(19) United States
(12) Patent Application Publication
(10) Pub. No.: US 2017/0129414 A1
(43) Pub. Date: May 11, 2017

(54) APPARATUS FOR USE WITH TRANSPORT TRUCK DECKING BAR

(71) Applicant: Total Transportation Solutions Inc., Toronto (CA)

(72) Inventors: Scott Timothy PUSTAI, Toronto (CA); Mike TACHE, Sunderland (CA)

(73) Assignee: Total Transportation Solutions Inc., Toronto (CA)

(21) Appl. No.: 14/934,373

(22) Filed: Nov. 6, 2015

(51) Int. Cl. B60R 11/00

(52) U.S. Cl. CPC B60R 11/00; B60R 2011/0036; B60R 2011/0084

(57) ABSTRACT

An apparatus is for use with a horizontal decking bar of a transport truck. The apparatus includes a decking-bar yoke configured to operatively engage with an infinite number of positions being located along an elongated length of the horizontal decking bar. A clamp assembly is configured to selectively securely connect the decking-bar yoke to a portion of the horizontal decking bar (at any one of the infinite number of positions being located along the elongated length of the horizontal decking bar).

### TECHNICAL FIELD

This document relates to the technical field of (and is not limited to) an apparatus for use with a horizontal decking bar of a transport truck, and the apparatus includes a decking-bar yoke and a clamp assembly (and method therefor).

### BACKGROUND

Logistic tracks are configured to keep cargo tied down (secured) during transport (via a shipping truck). Logistic tracks are mounted to the interior of a shipping truck, and may be manufactured under a standard system (such as, the E-type track, the A-type track and/or the F-type track). The logistics track is configured to provide an attachment point for a wide variety of interior van cargo control systems. Logistic tracks may be attached with screws, rivets or by welding. A specific fastener size and/or mounting method should be determined by the vehicle manufacturer or a qualified installer. Care should be taken to ensure that installation environments and materials do not create a potential for corrosion.

A horizontal decking bar (also called a load bar, a cargo bar, etc.) is configured to (A) secure cargo for transport, and (B) provide load safety by preventing shifting (of the cargo during transport) that might allow products not secured with cargo load bars to impact one another and cause damage. Cargo bars for trucks can stand alone or work with a track system. A ratcheting load bar can be used without a track system and uses pressure between the cargo and the bed or sidewall of the trailer to hold cargo in place. E-track cargo bars have end fittings that lock into strips of E-track installed on the interior of a cargo vehicle (truck). E-track load bars are available in steel or high strength aluminum and come with easy-to-use release mechanisms.

### SUMMARY

It will be appreciated that there exists a need to mitigate (at least in part) at least one problem associated with the existing horizontal decking bars (also called the existing technology). After much study of the known systems and methods with experimentation, an understanding of the problem and its solution has been identified and is articulated as follows:

Existing horizontal decking bars permit relatively limited flexibility in terms of loading the interior of the transport truck (as may be required so that the cargo load is evenly positioned in the transport truck and/or so that the amount of dead air space (unused space) in the interior of the transport truck is reduced.

What is needed is an apparatus that may be used with the horizontal decking bars in such a way that flexibility is improved (at least in part) for loading the interior of the transport truck (so that the cargo load may be more evenly positioned in the transport truck and/or the amount of dead air space in the interior of the transport truck may be reduced).

To mitigate, at least in part, at least one problem associated with the existing technology, there is provided (in accordance with a major aspect) an apparatus. The apparatus is for use with a horizontal decking bar of a transport truck. The apparatus includes a decking-bar yoke that is configured to operatively engage with (preferably, to couple to and to slide along) an infinite number of positions that are located along an elongated length of the horizontal decking bar. The apparatus also includes a clamp assembly that is configured to selectively securely connect the decking-bar yoke to a portion of the horizontal decking bar (at any one of the infinite number of positions being located along the elongated length of the horizontal decking bar).

To mitigate, at least in part, at least one problem associated with the existing technology, there is provided (in accordance with a major aspect) a method. The method is for operating an apparatus for use with a horizontal decking bar of a transport truck, the apparatus including a decking-bar yoke and a clamp assembly. The method includes (A) operatively engaging the decking-bar yoke with an infinite number of positions that are located along an elongated length of the horizontal decking bar, and (B) selectively securely connecting the decking-bar yoke to a portion of the horizontal decking bar with the clamp assembly (at any one of the infinite number of positions being located along the elongated length of the horizontal decking bar).

Other aspects are identified in the claims.

Other aspects and features of the non-limiting embodiments may now become apparent to those skilled in the art upon review of the following detailed description of the non-limiting embodiments with the accompanying drawings.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 depicts a view of an embodiment of a horizontal decking bar of a transport truck;

FIG. 2, FIG. 3, FIG. 4 and FIG. 5 depict views of embodiments of an apparatus for use with a horizontal decking bar of a transport truck of FIG. 1;

FIG. 6 and FIG. 7 depict views of embodiments of the apparatus of FIG. 2 and of the horizontal decking bar of FIG. 1 (respectively); and

FIG. 8, FIG. 9, FIG. 10, FIG. 11, FIG. 12, FIG. 13, FIG. 14, FIG. 15 and FIG. 16 depict views of embodiments of the apparatus of FIG. 2.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus
102 decking-bar yoke
104 clamp assembly
106 extension member
108 bicycle-frame support
110 pass-through hole
112 lock device
114 spaced apart hooks
900 horizontal decking bar
902 transport truck
904 vertical sidewalls
905 connecting elements
906 logistic tracks
908 load
910 bicycle frame
912 bicycle
914 wheels

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

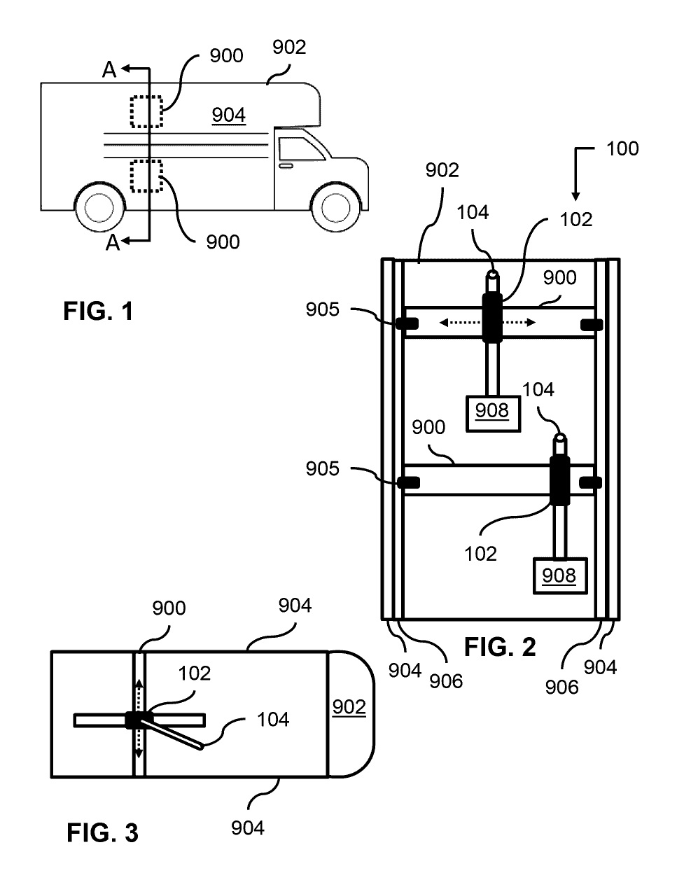

FIG. 1 depicts a view of an embodiment of a horizontal decking bar 900 of a transport truck 902. More specifically, FIG. 1 depicts a side view of an embodiment of the horizontal decking bar 900 and the transport truck 902.

In general terms, the horizontal decking bar 900 is configured to be operatively mounted to the transport truck 902. More preferably, the transport truck 902 has opposite vertical sidewalls 904 with logistic tracks 906 that are fixedly mounted to the opposite vertical sidewalls 904. The horizontal decking bar 900 is configured to extend horizontally across an interior of the transport truck 902 between the logistic tracks 906. Preferably, the horizontal decking bar 900 is configured to be fixedly connected to the logistic tracks 906 positioned on the opposite vertical sidewalls 904. More preferably, the horizontal decking bar 900 is configured to (A) fixedly mount with the logistic tracks 906, and (B) extend horizontally across an interior of the transport truck 902 between the logistic tracks 906. The opposite vertical sidewalls 904 are spaced apart from each other. The horizontal decking bar 900 may be called a cargo support beam, a retention bar, a horizontally extending bar, and any equivalent thereof. The logistic tracks 906 may be called a vertically aligned wall rail track, an e-tracks and any equivalent thereof.

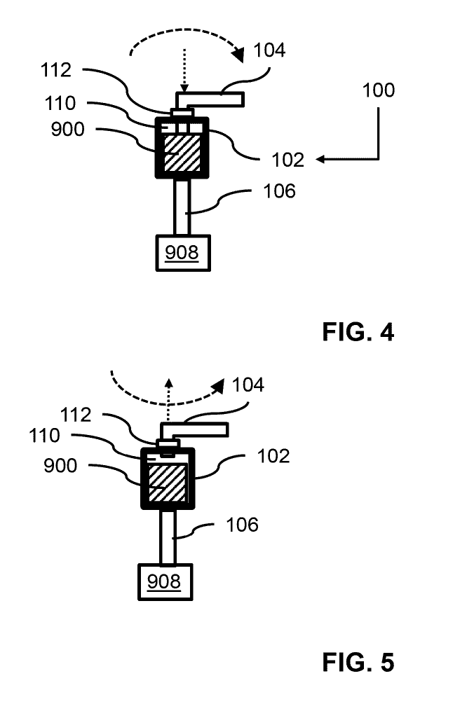

FIG. 2, FIG. 3, FIG. 4 and FIG. 5 depict views of embodiments of an apparatus 100 for use with the horizontal decking bar 900 of the transport truck 902 of FIG. 1. FIG. 2 depicts a cross-sectional view (taken along a cross-sectional line A-A of FIG. 1) of an embodiment of the apparatus 100 with the horizontal decking bar 900 and the transport truck 902 of FIG. 1. FIG. 3 depicts a top view of an embodiment of the apparatus 100, the horizontal decking bar 900 and the transport truck 902 of FIG. 2. FIG. 4 and FIG. 5 depict front views of embodiments of the apparatus 100 of FIG. 2.

Referring to the embodiment as depicted in FIG. 2 (and generally depicted in the remaining FIGS.), the apparatus 100 is for use with the horizontal decking bar 900 of the transport truck 902 of FIG. 1. The apparatus 100 includes a synergistic combination of a decking-bar yoke 102 and a clamp assembly 104.

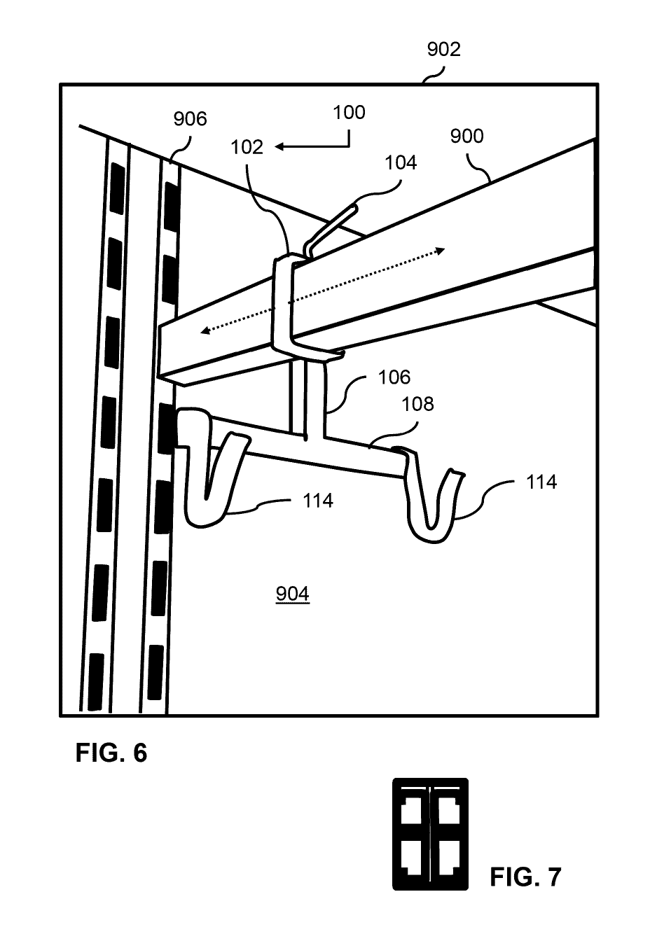

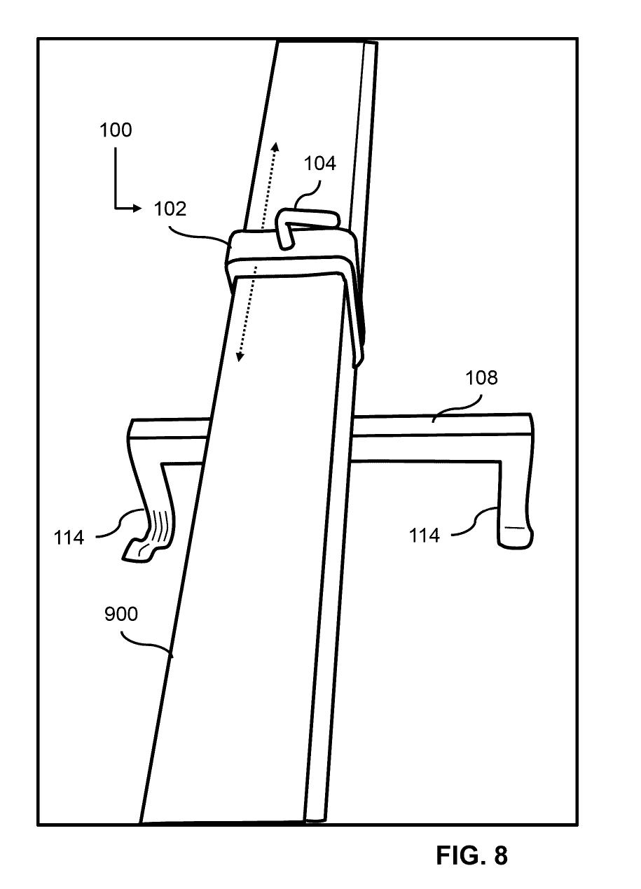

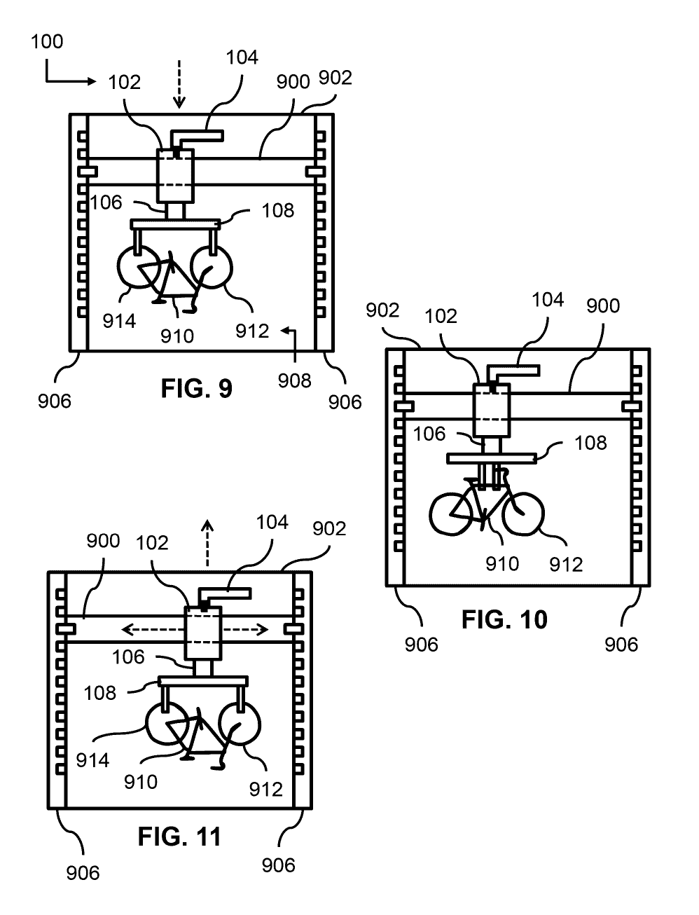

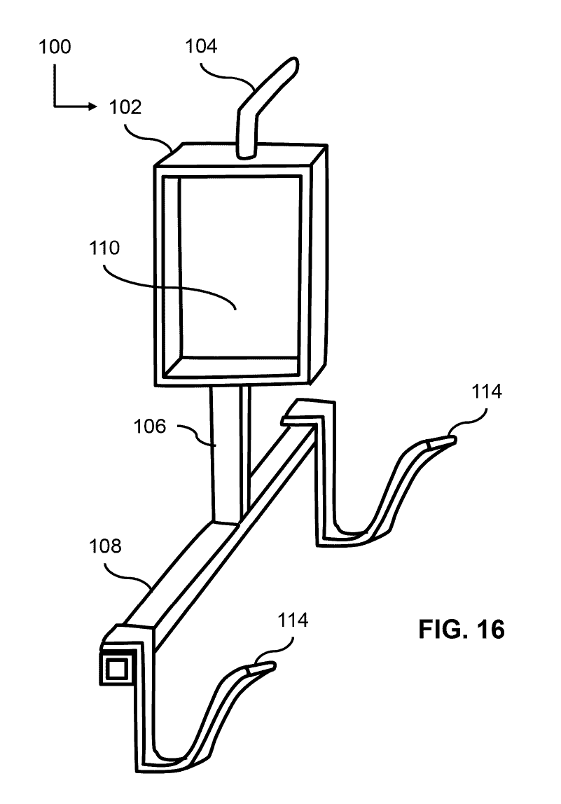

Generally, the decking-bar yoke 102 is configured to operatively engage (couple with) an infinite number of positions that are located along an elongated length of the horizontal decking bar 900 (as depicted in FIG. 2, FIG. 3, FIG. 6, FIG. 8 and FIG. 13).

Preferably (in accordance with an embodiment), the decking-bar yoke 102 is further configured to be spatially positioned and selectively movable (preferably, slidable) along the infinite number of positions located along the longitudinal length of the horizontal decking bar 900 (once the decking-bar yoke 102 is operatively engaged with the horizontal decking bar 900). Preferably, the decking-bar yoke 102 is configured to be spatially positionable at the infinite number of positions that are located along the elongated length of the horizontal decking bar 900. More preferably, the decking-bar yoke 102 is configured to be spatially positionable at, and movable to, the infinite number of positions that are located along the elongated length of the horizontal decking bar 900. More preferably, the decking-bar yoke 102 is configured to support a load 908 (as depicted in the embodiment of FIG. 2) once the decking-bar yoke 102 is operatively engaged with the horizontal decking bar 900. As depicted in the embodiment of FIG. 2, the load 908 includes a vertically hanging load that is supported by the decking-bar yoke 102. More preferably, the decking-bar yoke 102 is configured to be spatially positionable at the infinite number of positions that are located along the elongated length of the horizontal decking bar 900. Even more preferably, the decking-bar yoke 102 is configured to be spatially positioned at, and movable to, the infinite number of positions (that are located along the elongated length of the horizontal decking bar 900).

Generally, the clamp assembly 104 is configured to selectively securely connect (either directly or indirectly) the decking-bar yoke 102 to a portion of the horizontal decking bar 900 (at any one of the infinite number of positions being located along the elongated length of the horizontal decking bar 900).

Preferably (in accordance with an embodiment), the clamp assembly 104 is configured to securely connect the decking-bar yoke 102 at any one of the infinite number of positions that are located along the elongated length of the horizontal decking bar 900. For this case, the technical advantage of the clamp assembly 104 is that the clamp assembly 104 allows the user more flexibility for affixing the decking-bar yoke 102 to the horizontal decking bar 900 (as may be desired by the user) at any one of the infinite number of positions (that are located along the elongated length of the horizontal decking bar 900). The clamp assembly 104 allows the decking-bar yoke 102 to be spatially positioned and deployed (and then clamped to) at any one of the infinite number of positions (that are located along the elongated length of the horizontal decking bar 900). With this arrangement, the user may have better flexibility in terms of loading the interior of the transport truck 902 (as may be required so that the cargo load may be more evenly positioned in the transport truck 902 and/or so that the amount of dead air space in the interior of the transport truck 902 may be reduced).

Preferably (in accordance with an embodiment), the clamp assembly 104 is further configured to selectively securely connect (either directly or indirectly) the decking-bar yoke 102 to a portion of the horizontal decking bar 900 without the clamp assembly 104 physically altering (significantly amending or changing) the horizontal decking bar 900 (once the clamp assembly 104, in use, operatively connects or affixes the decking-bar yoke 102 at any one of the infinite number of positions that are located along the elongated length of the horizontal decking bar 900). Preferably, the clamp assembly 104 does not damage, inflict structural amendment and/or not impose any substantial harm to the horizontal decking bar 900. This is done in such a way that the horizontal decking bar 900 remains substantially structurally unaffected and unchanged by the operation of the clamp assembly 104. For this case, the technical advantage of the clamp assembly 104 is that the horizontal decking bar 900 may be redeployed for other purposes without concern simply because the clamp assembly 104 did not inflict or require structural amendments to the horizontal decking bar 900.

More preferably (in accordance with an embodiment), the clamp assembly 104 is further configured to selectively disconnect the decking-bar yoke 102 from the horizontal decking bar 900. This is done in such a way that the decking-bar yoke 102 is movable relative to the horizontal decking bar 900 once the clamp assembly 104, in use, disconnects the decking-bar yoke 102 from the horizontal decking bar 900.

A technical effect (of amongst many) of the apparatus 100 is that the apparatus 100 may secure and support items (cargo items) that are too fragile to be placed on the floor of the transport truck 902 during truck movements (specifically, the apparatus 100 may secure and support items at a position that is spaced apart from the floor of the transport truck 902 while the transport truck 902 is moving or being driven). The apparatus 100 may be used to secure items that are meant to be suspended (that is, spaced apart from the floor of the transport truck 902). The apparatus 100 may be used to suspend, cradle, or otherwise support the item (cargo item) in the transport truck 902 while the transport truck 902 is moved.

A technical effect (of amongst many) of the apparatus 100 is that the apparatus 100 may secure and support items (cargo items) that are of an odd shape that will not stand on its own once placed on the floor of the transport truck 902 during truck movements (specifically, the apparatus 100 may secure and support items at a position that is secured relative to the floor of the transport truck 902 while the transport truck 902 is moving or being driven). For instance, the items may have a shape that may allow the items to tip over without support while the transport truck 902 is moved.

In view of the foregoing, there is provided a method of operating the apparatus 100 for use with the horizontal decking bar 900 of the transport truck 902. The method includes (and is not limited to) (A) operatively engaging the decking-bar yoke 102 with an infinite number of positions that are located along an elongated length of the horizontal decking bar 900, and (B) selectively securely connecting the decking-bar yoke 102 to a portion of the horizontal decking bar 900 with the clamp assembly 104 (at any one of the infinite number of positions being located along the elongated length of the horizontal decking bar 900).

Referring to the embodiment as depicted in FIG. 2, there are two instances of the horizontal decking bar 900 mounted to the vertical sidewalls 904 (one above the other). The horizontal decking bar 900 is mounted to the logistic tracks 906 by connecting elements 905. Once the decking-bar yoke 102 is disconnected from the horizontal decking bar 900 (by deactivation of the clamp assembly 104), the decking-bar yoke 102 is movable between the logistic tracks 906 and along the horizontal decking bar 900.

Referring to the embodiment as depicted in FIG. 3, the logistic tracks 906 are not used (deployed) in the transport truck 902. For this case, the horizontal decking bar 900 is mounted (directly) to the vertical sidewalls 904. Once the decking-bar yoke 102 is disconnected from the horizontal decking bar 900 (by deactivation of the clamp assembly 104), the decking-bar yoke 102 is movable between the vertical sidewalls 904 and along the horizontal decking bar 900.

Referring to the embodiment as depicted in FIG. 4, the clamp assembly 104 is depicted as affixing (at least in part) the decking-bar yoke 102 to the horizontal decking bar 900 to a desired position on the horizontal decking bar 900 (specifically, to one of the infinite number of positions that are located along the elongated length of the horizontal decking bar 900). In FIG. 4, the clamp assembly 104 is rotated (turned) along a clockwise direction to tighten and secure the apparatus 100 to the horizontal decking bar 900 (in such a way that the apparatus 100 remains stationary relative to the horizontal decking bar 900).

Referring to the embodiment as depicted in FIG. 5, the clamp assembly 104 is depicted as disconnecting the decking-bar yoke 102 from the horizontal decking bar 900 (so that the decking-bar yoke 102 may be repositioned at any one of the infinite number of positions that are located along the elongated length of the horizontal decking bar 900). In FIG. 5, the clamp assembly 104 is rotated (turned) counter-clockwise in order to loosen the clamp assembly 104, and this is done in such a way that the apparatus 100 may slide (move) along a length of the horizontal decking bar 900 (preferably while the apparatus 100 remains slide engaged with the horizontal decking bar 900).

Referring to the embodiments as depicted in FIG. 4 and FIG. 5, the decking-bar yoke 102 is configured to support the load 908 (a vertical hangline load), either directly or indirectly.

Referring to the embodiments as depicted in FIG. 4 and FIG. 5, the apparatus 100 is adapted such that the decking-bar yoke 102 includes an extension member 106 that extends from the decking-bar yoke 102. The extension member 106 is configured to support the load 908 (either directly or indirectly). It will be appreciated that any type of load-support tool may be affixed (attached) to and extend from, the decking-bar yoke 102. Preferably, the decking-bar yoke 102 is configured to form a yoke having (forming) a pass-through hole 110 configured to receive the horizontal decking bar 900 (more preferably, to slidably receive the horizontal decking bar 900). It will be appreciated that other structural configurations for the decking-bar yoke 102 are possible and are within the scope of a person of skill in the art to determine. More preferably, the clamp assembly 104 is configured to (A) threadably engage with the decking-bar yoke 102, and (B) securely contact the horizontal decking bar 900 (once the clamp assembly 104 has threadably engaged the decking-bar yoke 102). The clamp assembly 104 is configured to be rotated (manually by a user). The clamp assembly 104 includes a threaded handle section. The clamp assembly 104 is configured to lock the spatial position of the decking-bar yoke 102 relative to the horizontal decking bar 900. For instance, the clamp assembly 104 includes a lock device 112 configured to lock the spatial position of the decking-bar yoke 102 relative to the horizontal decking bar 900 (such as, a threaded nut threadably engaged with threads of the clamp assembly 104). In summary, the clamp assembly 104 and the decking-bar yoke 102 are configured, in combination, to securely support a load 908 (a hanging load) while the clamp assembly 104, in use, clamps the decking-bar yoke 102 to the horizontal decking bar 900.

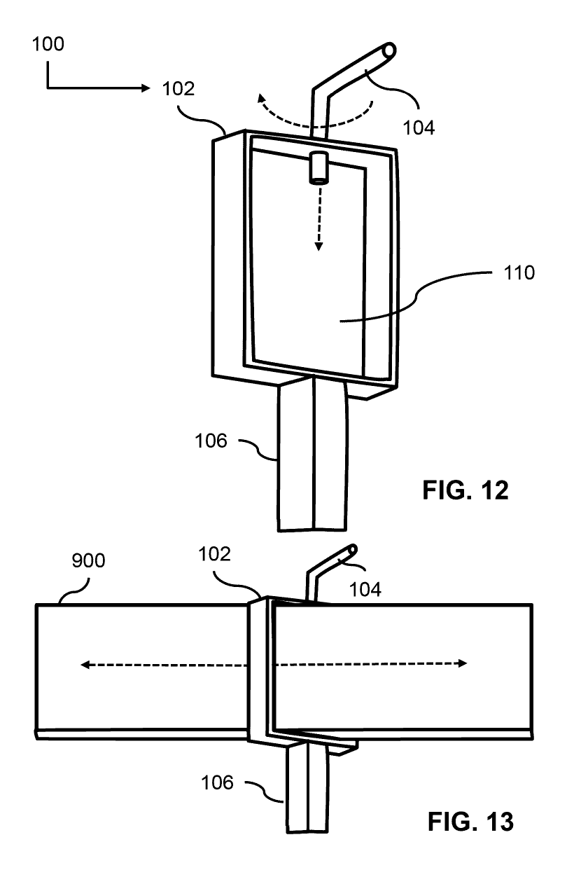

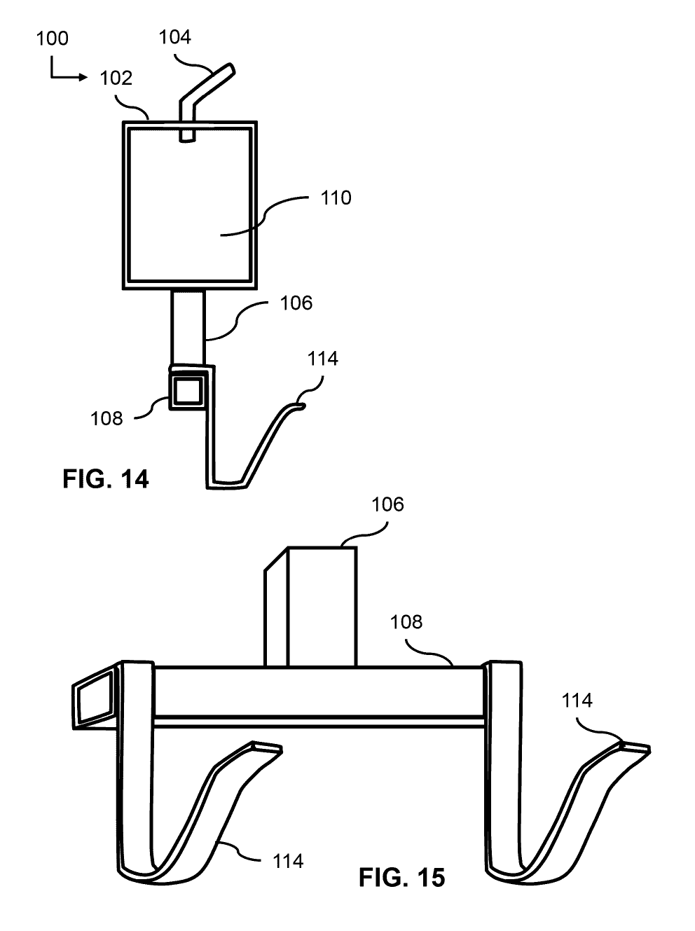

FIG. 6 and FIG. 7 depict views of embodiments of the apparatus 100 of FIG. 2 and of the horizontal decking bar 900 of FIG. 1 (respectively). FIG. 6 depicts a perspective side view of an embodiment of the apparatus 100 of FIG. 2. FIG. 7 depicts an end view of the horizontal decking bar 900 of FIG. 1.

Referring to the embodiment as depicted in FIG. 6, the extension member 106 includes a bicycle-frame support 108 that extends downwardly from the decking-bar yoke 102 (preferably, once the decking-bar yoke 102 is securely clamped or securely connected to the horizontal decking bar 900). Additional description for the bicycle-frame support 108 is provided in association with FIG. 8, FIG. 9, FIG. 10, FIG. 11, FIG. 14, FIG. 15 and FIG. 16. The bicycle-frame support 108 includes a pair of spaced apart hooks 114 that extend (depend) from opposite lateral sides of the bicycle-frame support 108. The spaced apart hooks 114 are configured to receive a bicycle 912 (as depicted in FIG. 9).

Referring to the embodiment as depicted in FIG. 7, the horizontal decking bar 900 includes multiple elongated members that are interconnected with each other and covered by a sleeve structure (known and, therefore, no further description is provided).

FIG. 8, FIG. 9, FIG. 10, FIG. 11, FIG. 12, FIG. 13, FIG. 14, FIG. 15 and FIG. 16 depict views of embodiments of the apparatus 100 of FIG. 2. FIG. 8 depicts a perspective top view of an embodiment of the apparatus 100 of FIG. 6. FIG. 9, FIG. 10 and FIG. 11 depict end views of embodiments of the apparatus 100 of FIG. 2. FIG. 12 and FIG. 13 depict perspective side views of embodiments of the apparatus 100 of FIG. 2. FIG. 14 depicts a side view of an embodiment of the apparatus 100 of FIG. 2. FIG. 15 and FIG. 16 depict perspective side views of embodiments of the apparatus 100 of FIG. 2.

Referring to the embodiment as depicted in FIG. 8, the bicycle-frame support 108 includes a pair of spaced apart hooks 114 that extend (depend) from opposite lateral sides of the bicycle-frame support 108.

Referring to the embodiments as depicted in FIG. 9, FIG. 10 and FIG. 11, the spaced apart hooks 114 are configured to receive a bicycle 912 (which is an example of the load 908). The bicycle-frame support 108 is configured to receive and support the bicycle frame 910 of the bicycle 912 once the decking-bar yoke 102 is spatially positioned on the horizontal decking bar 900 and is securely connected to the horizontal decking bar 900. Preferably, the bicycle-frame support 108 is configured to avoid imparting physical harm to the bicycle frame 910 once the bicycle frame 910 is received and supported just so. More preferably, the bicycle-frame support 108 includes a pair of spaced apart hooks 114 affixed to the bicycle-frame support 108. The bicycle-frame support 108 extends from the decking-bar yoke 102. Specifically, the bicycle-frame support 108 includes an outer surface, and includes a layer of resilient material (a layer of rubber material) positioned on the outer surface of the bicycle-frame support 108. The resilient material is configured to avoid imparting physical harm to the bicycle frame 910 once the bicycle frame 910 is received by the spaced apart hooks 114. For instance, the bicycle-frame support 108 is configured to contact the opposite sides of the bicycle frame 910. In accordance with an option, the bicycle-frame support 108 is configured to contact and support the bicycle frame 910 in such a way that the wheels 914 attached to the bicycle frame 910 are positioned below the bicycle frame 910 once the bicycle-frame support 108 receives and supports the bicycle frame 910. To depict the versatility of the apparatus 100, FIG. 9 and FIG. 11 depict the bicycle frame 910 in an upside position while FIG. 10 depicts the bicycle frame 910 in an upright position.

Referring to the embodiments as depicted in FIG. 12 and FIG. 13, the clamp assembly 104 is configured to (A) threadably engage with the decking-bar yoke 102, and (B) securely contact the horizontal decking bar 900 (once the clamp assembly 104 has threadably engaged the decking-bar yoke 102). The clamp assembly 104 is configured to be rotated (manually by a user). A distal end of the clamp assembly 104 extends through the decking-bar yoke 102 and may make secured contact with an outer surface of the horizontal decking bar 900 (as depicted in FIG. 13).

Referring to the embodiment as depicted in FIG. 14, FIG. 15 and FIG. 16, the bicycle-frame support 108 forms a tubular structure. The spaced apart hooks 114 include curved portions.

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. An apparatus for use with a horizontal decking bar of a transport truck, the apparatus comprising:
a decking-bar yoke being configured to operatively engage with an infinite number of positions being located along an elongated length of the horizontal decking bar; and
a clamp assembly being configured to selectively securely connect the decking-bar yoke to a portion of the horizontal decking bar at any one of the infinite number of positions being located along the elongated length of the horizontal decking bar.

2. The apparatus of claim 1, wherein:
the clamp assembly is configured to securely connect the decking-bar yoke at any one of the infinite number of positions that are located along the elongated length of the horizontal decking bar.

3. The apparatus of claim 1, wherein:
the clamp assembly is further configured to selectively securely connect the decking-bar yoke to the portion of the horizontal decking bar without the clamp assembly physically altering the horizontal decking bar once the clamp assembly, in use, operatively connects the decking-bar yoke at any one of the infinite number of positions that are located long the elongated length of the horizontal decking bar.

4. The apparatus of claim 1, wherein:
the clamp assembly does not damage, inflict structural amendment and impose any substantial harm to the horizontal decking bar in such a way that the horizontal decking bar remains substantially structurally unaffected and unchanged by operation of the clamp assembly.

5. The apparatus of claim 1, wherein:
the clamp assembly is further configured to selectively disconnect the decking-bar yoke from the horizontal decking bar. This is done in such a way that the decking-bar yoke is movable relative to the horizontal decking bar once the clamp assembly, in use, disconnects the decking-bar yoke from the horizontal decking bar.

6. The apparatus of claim 1, wherein:
the clamp assembly is configured to be rotated.

7. The apparatus of claim 1, wherein:
the clamp assembly is configured to lock spatial position of the decking-bar yoke relative to the horizontal decking bar.

8. The apparatus of claim 1, wherein:
the clamp assembly includes:
a lock device configured to lock spatial position of the decking-bar yoke relative to the horizontal decking bar.

9. The apparatus of claim 1, wherein:
the clamp assembly is configured to:
threadably engage with the decking-bar yoke; and
securely contact the horizontal decking bar once the clamp assembly has threadably engaged the decking-bar yoke.

10. The apparatus of claim 1, wherein:
the clamp assembly and the decking-bar yoke are configured, in combination, to securely support a load while the clamp assembly, in use, clamps the decking-bar yoke to the horizontal decking bar.

11. The apparatus of claim 1, wherein:
the decking-bar yoke is further configured to be spatially positioned at, and selectively movable along, the infinite number of positions located along a longitudinal length of the horizontal decking bar once the decking-bar yoke is operatively engaged with the horizontal decking bar.

12. The apparatus of claim 1, wherein:
the decking-bar yoke is configured to support a load once the decking-bar yoke is operatively engaged with the horizontal decking bar.

13. The apparatus of claim 1, wherein:
the decking-bar yoke includes:
an extension member extending from the decking-bar yoke; and
the extension member configured to support a load.

14. The apparatus of claim 1, wherein:
the decking-bar yoke is configured to form a yoke having a pass-through hole configured to slidably receive the horizontal decking bar.

15. The apparatus of claim 1, wherein:
the decking-bar yoke includes:
an extension member extending from the decking-bar yoke; and
the extension member includes:
a bicycle-frame support extending downwardly from the decking-bar yoke.

16. The apparatus of claim 15, wherein:
the bicycle-frame support includes:
a pair of spaced apart hooks extending from opposite lateral sides of the bicycle-frame support; and
spaced apart hooks being configured to receive a bicycle.

17. The apparatus of claim 16, wherein:
the bicycle-frame support is configured to receive and support a bicycle frame of the bicycle once the decking-bar yoke is spatially positioned on the horizontal decking bar and is securely connected to the horizontal decking bar.

18. The apparatus of claim 17, wherein:
the bicycle-frame support is configured to avoid imparting physical harm to the bicycle frame of the bicycle once the bicycle frame is received and supported just so; and
the bicycle-frame support includes:
an outer surface; and
a layer of resilient material positioned on the outer surface of the bicycle-frame support; and
the layer of resilient material being configured to avoid imparting physical harm to the bicycle frame once the bicycle frame is received by the spaced apart hooks.

19. The apparatus of claim 1, wherein:
the transport truck has opposite vertical sidewalls with logistic tracks that are fixedly mounted to the opposite vertical sidewalls; and
the opposite vertical sidewalls are spaced apart from each other; and
the horizontal decking bar is configured to extend horizontally across an interior of the transport truck between the logistic tracks; and
the horizontal decking bar is configured to be fixedly connected to the logistic tracks positioned on the opposite vertical sidewalls.

20. A method of operating an apparatus for use with a horizontal decking bar of a transport truck, the apparatus including a decking-bar yoke and a clamp assembly, the method comprising:
operatively engaging the decking-bar yoke with an infinite number of positions being located along an elongated length of the horizontal decking bar; and
selectively securely connecting the decking-bar yoke to a portion of the horizontal decking bar with the clamp assembly at any one of the infinite number of positions being located along the elongated length of the horizontal decking bar.
